(19) United States
(12) Patent Application Publication
(10) Pub. No.: US 2010/0310142 A1
(43) Pub. Date: Dec. 9, 2010

(54) METHOD FOR REMOTE MONITORING OF THE IMAGE DATA QUALITY IN ACQUISITIONS WITH AT LEAST ONE MEDICAL IMAGE ACQUISITION DEVICE

(76) Inventor: Katrin Christel Sprung, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/477,284

(22) Filed: Jun. 3, 2009

(30) Foreign Application Priority Data
Jun. 3, 2009 (DE) 10 2008 026 610.8

(51) Int. Cl. G06K 9/00

(52) U.S. Cl. 382/131

(57) ABSTRACT

In a method for remote monitoring of the image data quality in acquisitions with at least one medical image acquisition device that has a control and evaluation unit connected to a network, and workstation computers, connected to the network, with a display device (in particular at least one monitor), image data of a current patient associated with the image acquisition device for acquisition are transmitted over the network to the workstation computer immediately after the acquisition and possible post-processing. The image data are presented at the display device in parallel with data of an additional patient presently being assessed, with optical demarcation in a separate observation region.

### BACKGROUND OF THE INVENTION

1. Field of the Invention

The present invention concerns a method for remote monitoring of the image data quality in acquisitions with at least one medical image acquisition device.

2. Description of the Prior Art

It is frequently necessary that, for example, a physician must follow an examination of a patient with a medical image acquisition device (for example a magnetic resonance or computer tomography device) although this is conducted by another operator (for example a medical technology assistant). Generally, this involves assessing whether the acquired image data are suitable for a following finding or whether additional image data must be acquired.

In order to realize such a monitoring (for example of an emergency examination), a physician must normally leave his or her current workspace (in particular a current medical assessment) and personally go to the modality. The physician must thereby interrupt his or her current work and accordingly loses a great deal of time.

Another possibility is to retrieve images present in a central archive (for example on a central computer) after conclusion of the examination in order to be able to view them at his workspace. However, this results in the disadvantage that persons present at the image acquisition device must possibly wait on whether the physician approves the images, meaning that these are sufficient. The patient can leave the image acquisition device only after this, and the next patient can only be examined after this approval has been granted. During this time the image acquisition device is blocked for new acquisitions. The physician must also additionally interrupt his or her current finding process in order to load the images from the central archive in order to be able to consider them.

To solve this problem it was proposed to mount a secondary monitor at the workspace of the physician, which secondary monitor is connected with the image acquisition device in such a manner that the same information is displayed there that are also presented on a monitor that is arranged at the image acquisition device. The secondary monitor accordingly displays exactly the information that the operator conducting the examination also sees. However, this solution requires additional technical components and is limited to a specific workspace.

An additional solution approach proposes to enable what is known as a remote access so that whether the examining operator sees on the monitor arranged at the image acquisition device also can be shown to a different viewer at a different monitor at which he or she currently works. However, this disadvantageously requires additional work steps and the display of the running examination completely blocks the use of the workstation computer.

In summary, the problem currently exists that time losses must be accepted in order to ensure a monitoring of the image data quality by physicians who must be present at the image acquisition device or must interrupt their current work. The use of a secondary monitor is expensive and requires additional hardware or software. Furthermore, either blockades of the image acquisition device for waiting patients occur in the known procedures or the patient is initially released (in order to not interrupt the routine operation) and must possibly be reexamined later with the image acquisition device.

### SUMMARY OF THE INVENTION

An object of the present invention is to provide a method for monitoring the image data acquisition that is realized with low expenditure, entails optimally small time losses, and avoids the disadvantages of the prior art.

According to the invention, a method is provided for remote monitoring of the image data quality in acquisitions using at least one medical image acquisition device that has a control and evaluation unit connected to a network and workstation computers, connected to the network, with a display device (in particular at least one monitor). In the method according to the invention, image data of a current patient associated with the image acquisition device for acquisition are transmitted over the network to the workstation computer immediately after the acquisition and possible post-processing, and the image data are presented at the display device in parallel with data of an additional patient presently being assessed, with optical demarcation in a separate observation region.

According to the invention it is initially provided that the image data are already transmitted over the network to the workstation computer immediately after the acquisition and—in the event that the control and evaluation unit is fashioned for such—post-processing. This transmission can occur immediately, for example by the workstation computer sending a corresponding query to the control and evaluation unit, or also indirectly so that (for example) the control and evaluation unit sends the image data to a central computer (for example a central server) immediately after the conclusion of the acquisition or, respectively, post-processing, from which central computer they can be retrieved by the workstation computer. In contrast to the prior art, the (possibly post-processed) image data are thus directly available immediately and not only after conclusion of the entire or a partial examination. A user is thus presented with the possibility to monitor the image quality in acquisitions with the image acquisition device from his own workstation computer.

In order to enable this monitoring in an optimally low-effort, time-saving manner and without interruption of the current work of the user (in particular of the physician), according to the invention it is additionally provided that the image data are shown on the display device in parallel with data of an additional patient who is currently being assessed, with optical demarcation in a separate observation area. A portion of the display surface available is accordingly reserved for the monitoring of the image data quality. Although the finding region associated with the additional patient is thereby somewhat reduced, according to the invention it can be advantageously provided that the observation region is smaller than a finding area showing data of the additional patient. In this way it is enabled that a monitoring of the image data quality in parallel with the assessment of an additional patient is possible without the working process of the finding being appreciably limited. For example, no overlapping of the observation region with the finding region exists in the method according to the invention. No important data thus end up out of sight.

An optical demarcation of the observation region relative to the finding region should additionally be enabled. This allows the user to clearly and explicitly differentiate the image data associated with the patient immediately examined in the image acquisition device from the displayed data of the additional patient being assessed so that no confusion or association errors can occur at all. It is also made easier for the eyes of the user to quickly switch between the regions. According to the invention, for such a clear and explicit optical demarcation of the observation region it can be provided that this has a color background and/or is bordered by a thick (in particular dotted or solid) line; and/or the displayed image data are shown with the name of the patient and/or the name and/or the type of the modality in the background; and/or control and display elements are shown in a coloration or shading deviating from the presentation of the data of the additional patient. For example, if the observation region is shown as an observation window (known in many operating systems), this can exhibit a particularly thick (for example dotted or solid) line as a border. Additionally or alternatively, a color demarcation can occur via a background of the observation region, or via corresponding design of the control and display elements in the observation region. It is also advantageous to seek a display of the image data with text in the background. This text can comprise the name of the patient, the name or the type of the modality or other information that can be presented via text. It can particularly advantageously be provided that a corresponding text background is also enabled in the finding region.

The method according to the invention therefore in the first place offers the possibility to realize a low-cost monitoring in parallel with other work processes. This results in that image data from the image acquisition device are automatically made available over the network immediately after their completion, and in that the parallel display is enabled via a separate, optically demarcated observation region. Both time and technical effort are saved in this manner since no additional devices are required.

In a further embodiment of the method according to the invention, it can be provided that—in addition to the image data—control data of the image acquisition device are also transferred over the network and presented as additional information in the observation region. While it has previously been typical only to make the image data themselves digitally available over the network after the acquisition, the method according to the invention now proposes to also make control data of the image acquisition device available over the network in order to then display them, advantageously together with the current image data. Information that have thus previously been available only locally at the image data device itself can now comfortably be used for remote monitoring of the image data acquisition. For example, the acquisition time (in particular of currently displayed image data and/or image data currently involved in the acquisition procedure and/or of the entire examination procedure in the image acquisition device); and/or the progress of the entire examination procedure in the image acquisition device; and/or the image acquisition parameters being used; and/or information about a contrast agent (in particular the point in time of administration); and/or about the presence of the next patient following the current patient can be displayed as additional information derived from the control data. For example, in addition to the image data, the length of the entire examination of the patient (thus the generation of all exposures) is displayed in the observation region using a progress bar as well as how much of the total examination has already concluded, and how long the acquisition of the current image will still take (possibly also with a progress bar). It may also be indicated when a contrast agent is administered, for example. It is also advantageous to indicate whether a subsequent patient is already waiting, for example, or whether time would still be available anyway for additional acquisitions of the current patient. A number of items of additional information thus can be brought to the attention of a user (in particular a physician) via the provision of the control data.

In the method according to the invention, in addition to the image data, personal data of the patient (in particular from an electronic patient record and/or a hospital information system) can be transferred over the network and displayed in the observation region. Electronic patient records and/or hospital information systems (HIS) stored or running on a central computer and that administer the patient data (thus organizational data and health-related data) are frequently used, in particular in hospitals. According to the invention, an appropriate selection of these data can be retrieved over the network and displayed on the display device. In addition to the name of the patient, specific values (the age or the like) can be of interest, for example. Findings or diagnosis suspicions that have already occurred can also be displayed.

However, personal data of the patient can also be provided from the image acquisition device itself. For example, it can thus be provided that an EKG signal of the patient that is acquired via one component of the image acquisition device is transferred over the network and is displayed in the observation region. The physician can accordingly observe in real time the EKG signal of the patient that is acquired anyway by the image acquisition device, and can intervene if necessary.

The method according to the invention thus enables precisely the data that are relevant for monitoring to be displayed in the observation region. It is accordingly also no longer necessary to take on the entire display (which is overloaded with information unnecessary for the monitoring) on a monitor arranged at the image acquisition device. A user can particularly advantageously also configure which data or, respectively, which information should be displayed to him or her. The method according to the invention also spares resources in that ultimately only the information and functions that are actually necessary for monitoring are realized in the monitoring region.

Advantageously, only data of a patient associated with a user logged in at the workstation computer are displayed. In the event that a number of patients use the image acquisition device, only the image data (and additional information as necessary) for which the user is also responsible (that he thus must actually monitor) are displayed to the user.

Alternatively or additionally, only data associated with a specific criterion, in particular data of emergency patients, are shown. For example, such an embodiment is very advantageous for a physician who presently is on call for emergency service. The physician thus can immediately recognize acutely threatening cases and take corresponding measures.

In a further embodiment of the method, an interaction with the displayed image data by a user can ensue, in particular a marking of conspicuous regions and/or a measurement of conspicuities, wherein the measures that are taken are stored (in particular with image data stored on the network) and are displayed again given a later retrieval of the image data. If the user notices conspicuities during his monitoring activity, for example, he can already mark these image data displayed in the observation region as a type of preview window or, for example, can measure the size of a conspicuity. These data can then be stored together with the image data in a central computer (in the event that one is present), for example, and be displayed again given a retrieval. A basic functionality is thus provided by the method according to the invention, which functionality enables a first rough marking of details in the image data without immediately providing the entire functionality of an image processing system that would only unnecessarily load the system of the workstation computer and is also not necessary for a monitoring.

In principle, with the method according to the invention it is also possible to provide feedback on the part of the user at the workstation computer, which feedback is relayed to the image acquisition device via the network. For example, it can be provided that an operating element is displayed in the observation region; given the actuation of the operating element, the user clarifies his approval of the image data and the ending of the examination procedure, after which the actuation is transferred via the network to the image acquisition device and displayed there. In this way it can be ensured that the examination of the patient was sufficient and concluded so that the patient does not have to wait first until the physician has visited the image acquisition device himself, for example. The confirmation is displayed to an operator of the image acquisition device, whereupon this operator can end the examination.

Furthermore, it can be provided that a user inputs progress data concerning the progress of the examination procedure via a control and/or input element arranged in the observation region, whereupon the progress data are transferred to the image acquisition device via the network and are displayed there. For example, a variation of the image acquisition parameters for how the specific further images are desired can be elegantly communicated in this way to an operator of the image acquisition device.

In one development of the method, the display of the data in the observation region can be activated and/or deactivated by a user. In this way the user (thus the physician) can himself decide whether he or she would like to conduct a monitoring at the moment.

With the method according to the invention, the image acquisition at multiple image acquisition devices can also be monitored. Two basic embodiments of the method according to the invention can be used for this. Given monitoring of the image data quality in acquisitions with multiple image acquisition devices, the observation region is divided into correspondingly many sub-regions that are respectively associated with an image acquisition device.

A uniform division is particularly useful. The separate sub-regions are also optically demarcated from one another, for example have backgrounds with different colors or different texts.

In a preferred exemplary embodiment, given monitoring of the image data quality in acquisitions with multiple image acquisition devices, the observation region has a control element for changing between the presentation of image data of the different modalities, in particular an index card indicator for each image acquisition device. The space can be more effectively utilized in this way and the presented image data are not too small. The image acquisition devices can be selected according to the manner of “tabbed browsing” (known from Internet browsers, for example) via a control element replicated at an index card flag. A faster and simpler changing between the image acquisition devices is therefore possible.

If a central computer (already mentioned multiple times) is connected to the network, the image data and possible additional data pertaining to the patient are initially transferred to the central computer connected to the network (in particular into a patient file stored there and/or a hospital information system implemented there) immediately after their acquisition and possible post-processing, and then are transmitted from there to the workstation computer. All data are centrally administered in this way.

### BRIEF DESCRIPTION OF THE DRAWINGS

FIG. 1 shows a system in which the method according to the invention can be applied.

FIG. 2 is a flow chart plan of the method according to the invention.

FIG. 3 shows a display at two monitors.

FIG. 4 shows a possible display for additional information and patient data with input element.

FIG. 5 shows an observation region divided up for multiple image acquisition devices.

### DESCRIPTION OF THE PREFERRED EMBODIMENTS

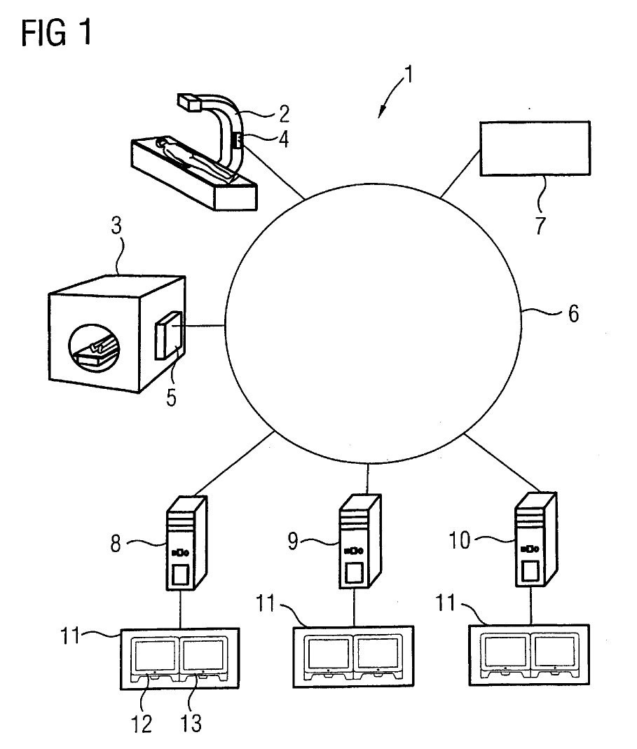

FIG. 1 shows a system 1 in which the method according to the invention can be applied. In the present example, the system is realized in a hospital. FIG. 1 shows two image acquisition devices 2, 3 (presently an x-ray device and a magnetic resonance device) provided in the hospital which respectively contain a control and evaluation unit 4, 5. The control and evaluation units 4, 5 are respectively connected with a network 6, for example an intranet. The system 1 furthermore has a central computer 7, in particular a server. Furthermore, workstation computers 8, 9, 10 (of which three pieces are exemplarily shown here with respective associated display devices 11 that have two monitors 12, 13) are connected to the network 6.

With the method according to the invention, in the system it is possible to monitor the image quality in acquisitions with the image acquisition devices 2, 3 at one of the workstation computers 8, 9, 10 in parallel with the assessment of an additional patient with low cost.

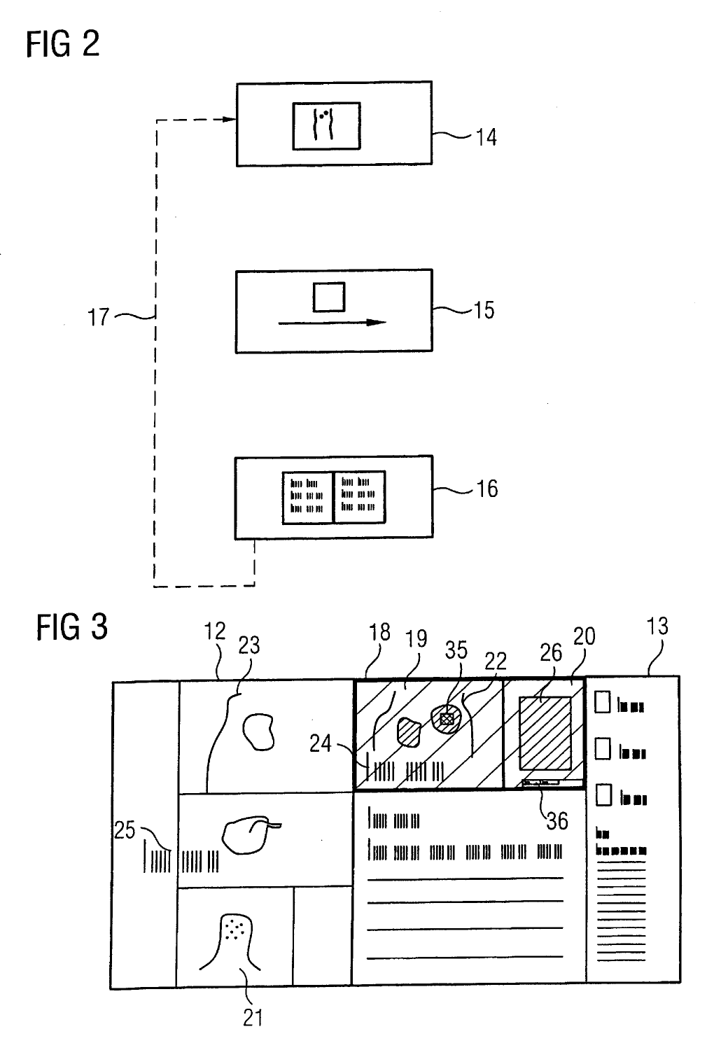

FIG. 2 shows a workflow plan of the method according to the method. While a specific patient is being examined (for example at the image acquisition device 3), image data are acquired (frequently in different acquisitions). This occurs in Step 14 of the method according to the invention. A post-processing of the image data is also contained in Step 14 (in the event that the control and evaluation unit 5 is fashioned for this). The currently examined patient is associated with a specific physician who would like to monitor the examination procedure from the workstation computer 8 while he simultaneously proceeds with his routine assessment of other patients.

According to the invention, in Step 15 the image data (and possibly also control data of the image acquisition device 3) are transferred over the network 6 to the workstation computer 8. In this exemplary embodiment it is provided that the (possibly post-processed) image data of an exposure are relayed to the central computer 7 immediately after their generation (even if additional acquisitions are to be executed) and there are stored in a patient file (in particular an electronic patient file) already associated with the patient. Alternatively, the patients can be administered by means of a hospital information system on the computer 7. From there the workstation computer 8 can now access the data over the network 6. The control data can also be transferred to the workstation computer 8 via the central computer 7, but the control data are relevant only for the monitoring of the image quality and do not necessarily need to be centrally stored, so that in this embodiment the control data are directly transmitted to the workstation computer 8. Naturally, however, other embodiments are also conceivable. In particular, the image data can also be directly transmitted to the workstation computer 8 instead of via the central computer 7. It is important that, in the method according to the invention, the data are made available promptly and not just after conclusion of the entire examination of the patient or via manual loading by the physician.

Furthermore, Step 15 also includes transferring personal data of the patient through the network 6. These data can originate both from the central computer 7 (for example from an electronic patient record and/or a hospital information system) or even from the corresponding image acquisition device 3. For example, in the scope of the method according to the invention an EKG signal of the patient that is acquired by a component of the image acquisition device 3 can be transferred via the network 6.

In Step 16 the data are now shown on the presentation device 11 parallel to data of a currently assessed additional patient, optically demarcated in a separate observation region. In the following this is explained in detail with reference to FIG. 3-5. A user thus can select both whether the observation region should currently be visible at all (meaning that the monitoring can be activated or deactivated) and which of the items of information or, respectively, data should actually be displayed. The data can easily be differentiated from those of the additional patient due to the clear and distinct optical demarcation and the use of a separate region. Nevertheless, the assessment of the additional patients can be conducted parallel to the monitoring such that no time loss occurs.

The displayed image data or, respectively, other information and data are naturally continuously kept up to date, as is indicated by the arrow 17. If the examination of a patient is concluded or, respectively, if it is declared (by means of a suitable control element in the observation region) as concluded by the physician at the workstation computer 8 (which can occur in the method according to the invention via actuation of a control element and transmission of the corresponding information over the network 6), it is checked whether the next patient is also associated with this physician, and if necessary the data of this patient are displayed in the observation region. Otherwise, the observation region is masked out and used for the assessment activity of the physician. As an alternative to the selection of the image data to be displayed using the association of the patient with the user, it is also possible in the method according to the invention to show only data associated with a specific criterion. For example, these can be data of emergency patients for whom a fast intervention is required. Naturally, a cumulative application of both selection criteria is also conceivable.

FIG. 3 shows a possible presentation on the display device 11 with the monitors 12 and 13. The observation region 20 on the right monitor 13 is clearly recognizable (i.e. optically demarcated, in the present case by a thick border 18 and a different coloration indicated by a hatching 10) as not to be identified with the remaining, overlapping (thus separate) region. The remainder of the display surface on the monitors 12 and 13 is furthermore used for assessment of an additional patient or for system functions, and should be designated in the following as an assessment region 21. The current (presently the first acquired) image data 22 of a current patient associated with the image acquisition device 3 for acquisition are initially shown in the observation region 20. An additional, clear possibility for differentiation from the image data of an additional assessed patient (shown on the monitor 12, for example) is that text 24 or 25 is used as a background for both the image data 22 and the image data 23. This text can display the name of the patient, however, in the case of the text 24 it is also name and type of the monitored image acquisition device 3.

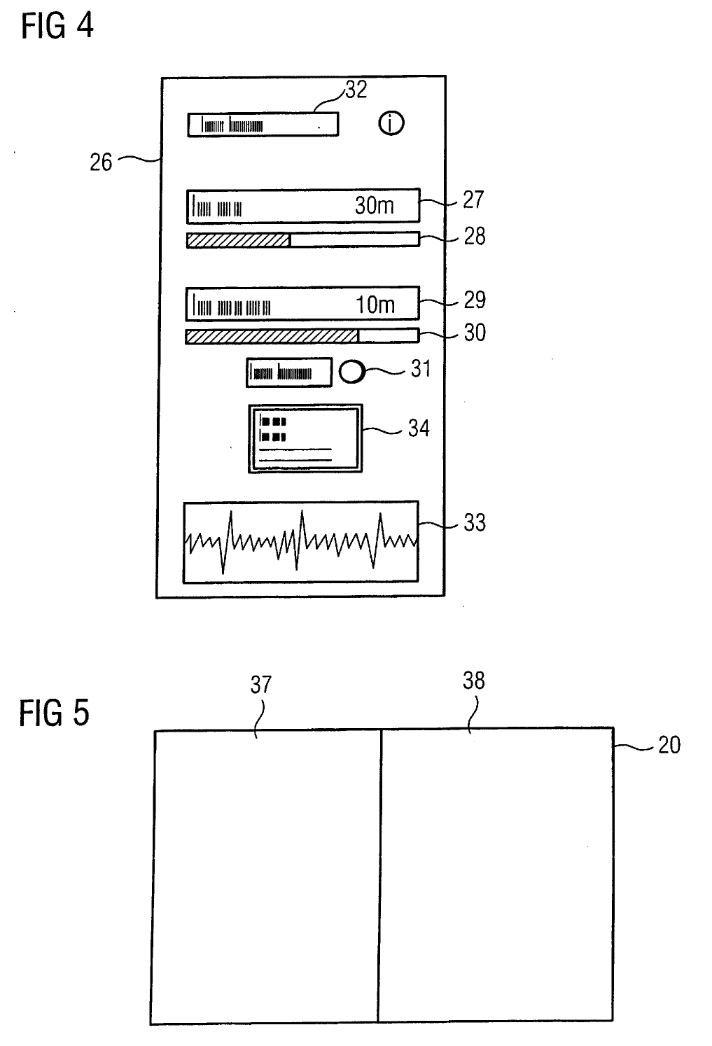

Additional information and data as well as control elements are shown in a sub-region 26 of the observation region 20 that is explained in detail via FIG. 4.

FIG. 4 shows a possible information window 26 in the framework of the present invention. Various additional items of different information and data are shown therein that can be advantageous in the monitoring. The total duration of the examination is presently displayed in a region 27 while a progress bar 28 indicates how much of this time has already passed. A region 29 indicates when the injection of a contrast agent should occur, and an additional progress bar 30 indicates how much of this time has already elapsed. An illuminated display element 31 indicates whether an additional patient is already waiting, or if time still remains for additional acquisitions. The information cited before can be derived from control data of the image acquisition device 3. Furthermore, personal data of the patient are additionally displayed, for instance his name in the region 32 and an EKG (which is acquired by the image acquisition device 3) in the region 33. Personal data can also originate from the central computer 7, for example from an electronic patient file or from a hospital information system. In the method according to the invention, the sub-region 26 or in general the observation region 20 can also be configured to display additional information and data, for example: the acquisition time for data involved in the acquisition process; the image acquisition parameters in use; additional information about a contrast agent; information regarding pathology history of the patient; information regarding posed diagnoses; organizational data etc.; in short, all data that can be of use in the monitoring of the acquisition process.

The sub-region 26 furthermore has a control element 34 with which the user at the workstation computer 8 can confirm that he approves of the previously acquired image data and the examination can be concluded. Information about the actuation of the control element 34 are sent to the image acquisition device 3 and displayed there. In principle, in the present invention it is also conceivable to provide additional control and input elements with which (for example) image acquisition parameters or the like can be sent to the image acquisition device 3.

Finally, in the observation region 20 (FIG. 3) the user also has the possibility to use basic simple functions (for example in order to mark conspicuities in the image data 22, as is indicated by the marking 35). These measures are stored together with the image data (for example on the central computer 7). Given a retrieval, they are displayed again. Simple, basic interactions with the image data 22 are thus possible without, however, overloading the observation region 20 and the resources of the system, since it only involves an observation, and not yet a finding or the like yet.

Furthermore, control elements 36 similar to index card flags are provided in FIG. 3 with which, given multiple image acquisition devices, these can be switched between (presently between the image acquisition devices 2 and 3, for example) in the manner of “tabbed browsing”.

An additional variant for monitoring multiple image acquisition devices is schematically shown in FIG. 5. In this the observation region 20 is divided up into two sub-regions 37, 38 that are respectively associated with an image acquisition device (for example 2 or 3). The monitoring of a greater number of image acquisition devices with the method according to the invention is naturally also possible.

Although modifications and changes may be suggested by those skilled in the art, it is the intention of the inventor to embody within the patent warranted hereon all changes and modifications as reasonably and properly come within the scope of her contribution to the art.

I claim as my invention:

1. A method for remotely monitoring a quality of image data acquired using at least one medical image acquisition device, comprising the steps of:
acquiring medical image data from a first patient using a medical image acquisition device comprising a processor connectable to a data transmission network;
at a display of a workstation computer, also connectable to said data transmission network, assessing, at said display, medical images of a second patient;
immediately after acquisition of said medical image data with said medical acquisition device, establishing data transmitting communication between said processor and said workstation via said network and transmitting said medical image data from said processor to said workstation; and
simultaneously displaying said medical image data of said first patient at said display of said workstation with said medical image data of said second patient respectively in separately observation regions of said display, with an optical demarcation between said separate observation regions.

2. A method as claimed in claim 1 comprising post-processing said medical image data of said first patient before transmitting said medical image data of said first patient via said network to said workstation.

3. A method as claimed in claim 1 comprising displaying said medical image data of said first patient in an observation region at said display of said workstation that is smaller than an observation region at said display at which said medical image data of said second patient are displayed.

4. A method as claimed in claim 1 comprising optically demarcating said separate observation regions at said display of said workstation by a demarcation selected from the group consisting of differently coloring said separate observation regions, bordering at least one of said observation regions with a line, displaying respective names of said first and second patients in direct visual association with the medical image data of the first patient and the medical image data of the second patient, respectively, background display of different imaging modalities, and different shadings.

5. A method as claimed in claim 1 comprising, in addition to said medical image data of said first patient, transmitting from said processor to said workstation, via said network, control data of the image acquisition device used to generate said medical image data of said first patient, and simultaneously displaying said control data at said display of said workstation in the separate observation region in which said medical image data of said first patient are displayed.

6. A method as claimed in claim 5 comprising transmitting control data selected from the group consisting a time of acquisition of said medical image data of the first patient, a duration required for acquisition of said medical image data of the first patient, and indication of progress through an entire examination procedure of said first patient, of which the acquisition of said medical image data from the first patient is a part, a time of administration of a contrast agent to the first patient during acquisition of said medical image data of the first patient, and an indication of the presence of a next patient to be examined with said medical image acquisition device following said first patient.

7. A method as claimed in claim 1 comprising, in addition to said medical image data of said first patient, transmitting personal data of the first patient from said processor to said workstation via said network, and simultaneously displaying said personal data of the first patient in the separate observation region of the display at said workstation at which the medical image data of the first patient are displayed.

8. A method as claimed in claim 7 comprising automatically transferring said persona data of the patient from a data source selected from the group consisting of an electronic patient record of the patient and a hospital information system of a hospital in which the medical image acquisition device is located.

9. A method as claimed in claim 7 comprising transmitting an EKG signal of the first patient as said personal data.

10. A method as claimed in claim 1 comprising displaying said medical image data of said second patient at said workstation for assessment of said medical image data of the second patient by a user of the workstation, and logging the user into the workstation, and transmitting said medical image data of said first patient from said processor to said workstation via said network only if said first patient is a patient associated with said user of said workstation.

11. A method as claimed in claim 1 comprising transmitting said medical image data of said first patient from said processor to said workstation via said network only if a predetermined criterion is satisfied.

12. A method as claimed in claim 11 comprising employing, as said predetermined criterion, a determination that said first patient qualifies as an emergency patient.

13. A method as claimed in claim 1 comprising, at said workstation, making a designation, representing a medical assessment, by user interaction with said display, in said medical image data of the first patient, and automatically electronically storing said indication together with said medical image data of said first patient.

14. A method as claimed in claim 1 comprising, at said display of said workstation, displaying an actuatable element and, upon completion of viewing of said medical image data of said first patient at said workstation, actuating said actuatable element by user interaction with said workstation and transmitting an indication of actuation of said actuatable element back to said medical image acquisition device from said workstation via said network.

15. A method as claimed in claim 1 comprising entering, by user interaction via said display at said workstation, an indication of progress of an examination procedure involving said first patient, and automatically transmitting said indication via said network from said workstation to said image acquisition device, and displaying said indication at said image acquisition device.

16. A method as claimed in claim 1 comprising allowing activation or deactivation by a user of the display of said medical image data of said first patient at said workstation.

17. A method as claimed in claim 1 wherein said image acquisition device is a first image acquisition device, and comprising generating additional image data of said first patient with at least one additional image acquisition device, and, from each additional image acquisition device, transferring the medical image data of the first patient generated thereby, via said network to said workstation, and simultaneously displaying at said workstation, in separately demarcated respective observation regions, said image data of said first patient acquired with said first image data acquisition device and each of said additional image acquisition devices.

18. A method as claimed in claim 17 comprising allowing switching among presentation of said medical image data of said first patient acquired with said first image acquisition device and said additional image acquisition devices.

19. A method as claimed in claim 1 comprising transferring said medical image data from said image data acquisition device initially to a central computer connected to said network, and transmitting said medical image data of said first patient to said workstation from said central computer via said network.
